(19) United States
(12) Patent Application Publication
(10) Pub. No.: US 2023/0068437 A1
(43) Pub. Date: Mar. 2, 2023

(54) USING USER-SIDE CONTEXTUAL FACTORS TO PREDICT CELLULAR RADIO THROUGHPUT

(71) Applicant: Regents of the University of Minnesota, Minneapolis, MN (US)

(72) Inventors: Arvind Narayanan, Maple Grove, MN (US); Eman Ramadan, Riverside, CA (US); Feng Qian, Minneapolis, MN (US); Zhi-Li Zhang, Eden Prairie, MN (US)

(21) Appl. No.: 17/820,833

(22) Filed: Aug. 18, 2022

Related U.S. Application Data
(60) Provisional application No. 63/260,385, filed on Aug. 18, 2021.

(51) Int. Cl. H04W 24/02; H04W 24/08

(52) U.S. Cl. CPC H04W 24/02; H04W 24/08

(57) ABSTRACT

A system and method for predicting one or more cellular performance parameters associated with user equipment (UE) within a three-dimensional (3D) space having one or more cellular nodes, the cellular nodes including one or more cellular nodes, including a 5G cellular node. For each of one or more of pieces of UE within the 3D space, determine values associated with one or more UE-side features of each piece of UE. Predict values of the one or more cellular performance parameters for each UE as a function of the values associated with the one or more UE-side features of each respective piece of UE, wherein predicting values of the one or more cellular performance parameters includes applying the values determined for each respective piece of UE to a machine learning module trained using truth data associated with the one or more UE-side features.

This application claims the benefit of U.S. Provisional Patent Application No. 63/260,385, filed 18 Aug. 2021, the entire contents of which is incorporated herein by reference.

### GOVERNMENT INTEREST

This invention was made with government support under CNS-1915122 awarded by the National Science Foundation (NSF) and CNS-1901103 awarded by the National Science Foundation (NSF). The government has certain rights in the invention.

### TECHNICAL FIELD

This disclosure generally relates to cellular telephone technology and, in particular, to the use of machine learning to predict of throughput performance of cellular networks.

### BACKGROUND

Commercial fifth generation (5G) networks are quickly rolling out in the U.S. All the major U.S. cellular carriers now offer 5G services. In theory, 5G can support throughput of up to 20 Gyps—a 100× improvement compared to 4G. This is achieved by a series of innovations, such as millimeter wave (mmWave), massive multiple input, multiple output (MIMO) beamforming, advanced channel coding, and scalable modulation. 5G provides a desirable communication channel over the “last mile” between client devices and edge nodes, enabling revolutionary mobile/networked applications, such as mobile machine learning, networked virtual reality (VR)/augmented reality (AR), collaborative and autonomous vehicles (LAN's), low-latency Internet-of-Things (IoT) applications, and data-intensive sensing. To fully unleash the power of 5G, however, most such applications will benefit from edge computing, which brings computation and data storage closer to end hosts (e.g., mobile devices, CAVs, and IoT devices), reducing response time and ensuring that the wide-area Internet is less likely to become the performance bottleneck.

There remain, however, major challenges in leveraging commercial 5G networks to boost the service quality and resource efficiency of edge computing. For instance, at the physical layer, 5G uses two frequency ranges: sub-6 GHz range and mmWave range. Sub-6 GHz or mid-band frequency (1-6 GHz) 5G provides a “middle-ground” solution for initial 5G service deployment. With radio signals largely remaining omni-directional, its potential speed is, however, much slower than 5G mmWave.

5G mmWave radios operate at high frequencies (about 24 to 53 GHz) with abundant free spectrum. 5G mmWave is, therefore, lightning fast; it is considered to be the dominant technology for 5G in the long term. On the negative side, mmWave signals propagate in a pseudo-optical manner, and are vulnerable to attenuation and blockage despite the use of a beamforming algorithm that attempts to “recalibrate” the radio beam by seeking for a reflective non-line-of-sight (NLoS) path. This makes its performance fluctuate in real-world environments, severely hurting the service quality of, for instance, edge computing systems.

Another challenge is that cellular interfaces incur high energy consumption. For 3G/4G radios, their energy drain accounts for ⅓ to ½ of the overall energy consumption of a mobile device (e.g., a smartphone). The corresponding portion of energy consumption for 5G is even higher.

Yet another challenge is that 5G enables numerous emerging applications that incur high complexity (e.g., volumetric video) or high-performance requirements (e.g., autonomous driving), compared to applications supported by 4G. When using edge computing to support/enhance these applications, the solution space may further inflate, leading to complex tradeoffs between computation and network resource utilization. How to balance such tradeoffs in a principled manner by judiciously determining whether to offload, what to offload, and how to offload is a very challenging problem.

### SUMMARY

In general, as noted above, emerging 5G services offer numerous new opportunities for networked applications. The present disclosure provides techniques for predicting the throughput of mmWave 5G in real-life environments and describes machine learning models for predicting 5G throughput in such environments. The disclosure identifies key user equipment (UE) side factors that affect 5G performance and quantify the extent to which 5G throughput can be predicted. The disclosure further describes a composable machine learning (ML) framework that judiciously considers features and their combinations, and that applies state-of-the-art ML techniques for making context-aware 5G throughput predictions. The throughput prediction techniques described may be used to support applications such as a dynamic 5G throughput map (akin to Google traffic map) and other 5G-aware applications. In addition, the prediction techniques described may be used to predict parameters such as signal strength (e.g., Reference Signal Received Power (RSRP) or Reference Signal Received Quality (RSRQ)), level of carrier aggregation (e.g., 1CA, 4CA, 8CA) and uplink throughput.

The present disclosure further describes robust and accurate methods that provide quick and accurate predictions of 5G performance without (or with little) active probing. The present disclosure describes a data-driven approach, constructing a performance model for user equipment (UE) using a wide variety of carefully selected, robust, and easy-to-collect features. Such a data-driven approach is then used to automatically model the UE device and the complex relationships between the device's various “contexts” and 5G network performance, in particular for the environment-sensitive 5G mmWave radio. In one example, this prediction framework provides a high-resolution 5G “performance map” that may be used as a fundamental infrastructural service for 5G edge computing.

In addition, the present disclosure describes techniques for adaptively augmenting 5G using slower but more reliable Fourth Generation Long-term Evolution (4G UE) networks (or other wireless technologies such as WiFi), when needed. Such techniques ensure reliable edge offloading with certain guaranteed network performance. In one example approach, the technique applies a transport-layer multipath scheduler and an application-layer data refactoring scheme. Together, the transport-layer multipath scheduler and the application-layer data refactoring scheme act to make judicious multipath decisions by considering the heterogeneous performance of 5G/4G networks, their diverse energy characteristics, and application semantics.

In one example, a method for predicting one or more cellular performance parameters associated with user equipment (UE) within a three-dimensional (3D) space having one or more cellular nodes, the cellular nodes including one or more cellular nodes, including a 5G cellular node is described. The method includes determining, for each of one or more of pieces of UE within the 3D space, values associated with one or more UE-side features of each piece of UE; and predicting values of the one or more cellular performance parameters for each UE as a function of the values associated with the one or more UE-side features of each respective piece of UE, wherein predicting values of the one or more cellular performance parameters includes applying the values determined for each respective piece of UE to a machine learning module trained using truth data associated with the one or more UE-side features.

In another example, a system includes one or more cellular nodes, including one or more 5G panels; and a computing system connected to the cellular nodes, the computing system including a machine learning module, wherein the computing system is configured to determine, for each of one or more pieces of user equipment (UE) within a 3D space surrounding the plurality of cellular nodes, values associated with one or more UE-side features of each piece of UE, and wherein the machine learning module is trained to predict values of one or more cellular performance parameters for each piece of UE as a function of the values associated with the one or more UE-side features of each respective piece of UE, wherein predicting values of the one or more cellular performance parameters includes applying the values determined for each respective piece of UE to the machine learning module after the machine learning module has been trained using truth data associated with the one or more UE-side features.

In yet another example, a non-transitory, computer-readable medium includes executable instructions, which when executed by processing circuitry, cause a computing device to determine, for each of one or more of pieces of UE within a 3D space, values associated with one or more UE-side features of each piece of UE; and predict values of the one or more cellular performance parameters for each UE as a function of the values associated with the one or more UE-side features of each respective piece of UE, wherein predicting values of the one or more cellular performance parameters includes applying the values determined for each respective piece of UE to a machine learning module trained using truth data associated with the one or more UE-side features.

In yet another example, a method for predicting cellular performance for user equipment (UE) within a three-dimensional (3D) space having a plurality of cellular nodes, the cellular nodes including two or more 5G panels and at least one 4G tower, the method comprising estimating 4G cellular performance for each UE; determining, for each of a plurality of pieces of UE within the 3D space, values associated with one or more UE-side features of each piece of UE, estimating 5G cellular performance for each UE as a function of the values, wherein estimating cellular performance includes applying the values to a machine learning module trained using truth data associated with the one or more UE-side features: and determining, for each piece of UE and based on the estimated 4G cellular data performance and the estimated 5G cellular data performance, a combination of 4G data traffic and 5G data traffic needed to optimize cellular performance across the plurality of pieces of UE.

Details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is a block diagram illustrating an example system for cell classification, in accordance with one or more techniques of this disclosure.

FIG. 2 is a block diagram illustrating an example computing device within one of the example architectures of FIG. 1, in accordance with one or more techniques of the disclosure.

FIG. 3 illustrates an example of the machine learning system of FIG. 1, in accordance with one or more techniques of the disclosure.

FIG. 4 illustrates the classification results for both GDBT and Seq2Seq models under different feature groupings, in accordance with one or more techniques of the disclosure.

FIG. 5 illustrates the regression results for both GDBT and Seq2Seq models under different feature groupings, in accordance with one or more techniques of the disclosure.

FIG. 6 provides a performance comparison of baseline models with the GDBT and Seq2Seq models under different feature groupings, in accordance with one or more techniques of the disclosure.

FIG. 7 illustrates an edge computing system, in accordance with one or more techniques of the disclosure.

FIGS. 8A and 8B illustrate leveraging application semantics at the application layer to intelligently deliver content over different types of cellular nodes, in accordance with one or more techniques of the disclosure.

FIG. 9 illustrates smart edge unloading, in accordance with one or more techniques of the disclosure.

FIG. 10 illustrates one example of the computing system of FIG in accordance with one or more techniques of the disclosure.

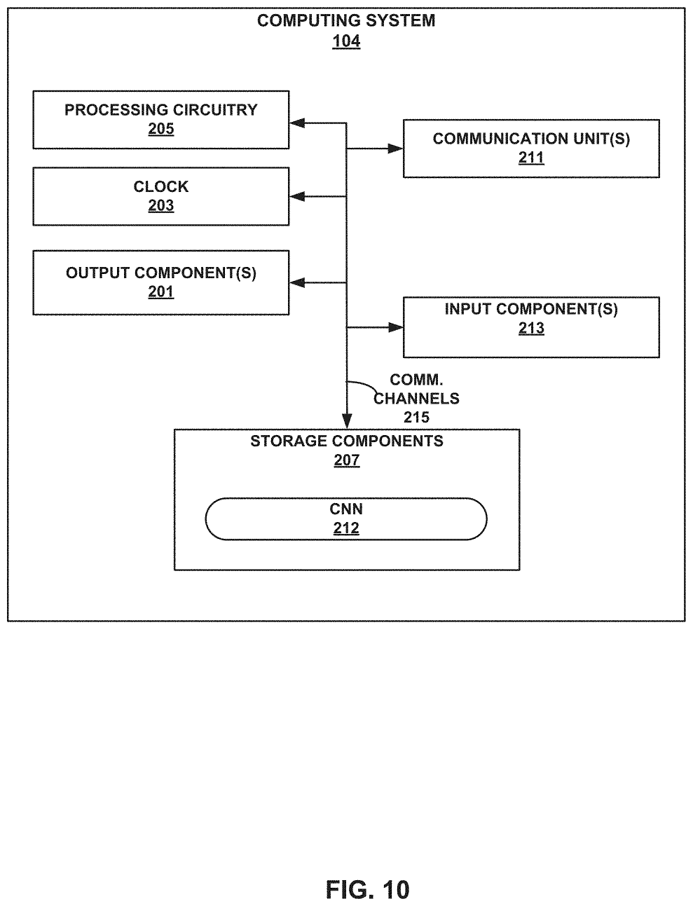

Like reference characters refer to like elements throughout the figures and description.

### DETAILED DESCRIPTION

The emerging 5G services offer numerous opportunities for networked applications that can take advantage of the increased data rates. Throughput in mmWave 5G can vary significantly with movement by the user. It can therefor be advantageous to be able to the throughput of mmWave 5G in different conditions. It can also be advantageous to employ machine learning models for 5G throughput prediction.

A measurement study was conducted of commercial mmWave 5G services in a major U.S. city, focusing on the throughput as perceived by applications running on user equipment (UE). UE-side factors that affect 5G performance were identified and used to determine the extent to which mmWave 5G throughput can be predicted on UE. A composable machine learning (ML) framework was developed that judiciously considers features and their combinations and applies state-of-the-art ML techniques for making context-aware 5G throughput predictions. In one example approach, the framework achieves 1.37× to 4.84× reduction in prediction error over existing models.

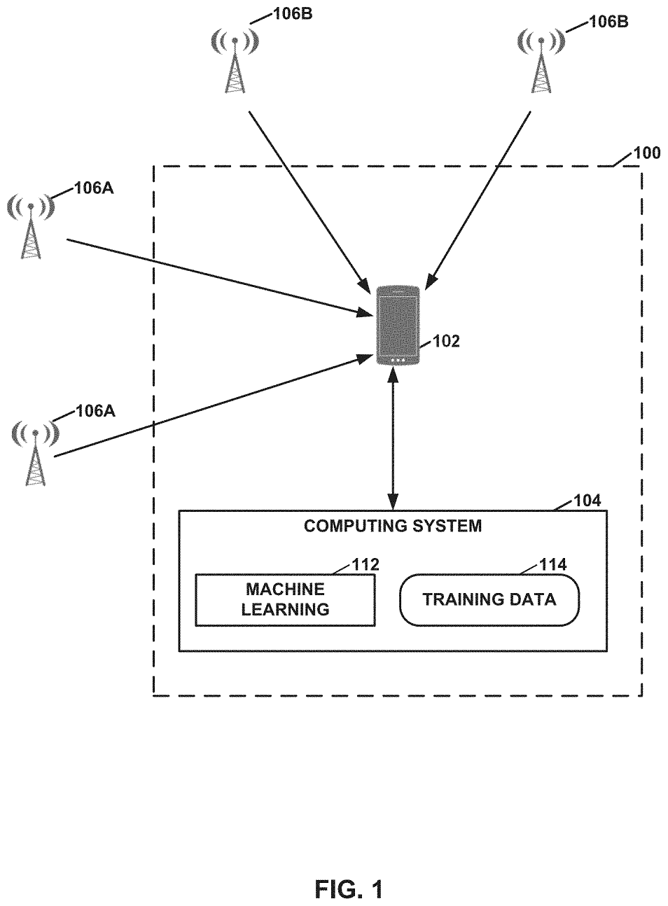

FIG. 1 is a block diagram illustrating an example system for predicting user equipment 5G throughput, in accordance with one or more techniques of this disclosure. 5G performance and, in particular, mmWave 5G performance is important for several reasons. The ultra-high bandwidth (theoretically up to 20 Gbps) of mmWave 5G offers exciting new opportunities to support a variety of emerging and future bandwidth-intensive applications expected of the 5G eMBB service. There are, on the other hand, technical challenges facing mmWave radios, making the design and management of 5G services based on mmWave radio a daunting task. For example, due to the directionality and limited range of mmWave radio and its high sensitivity to obstructions (e.g., surrounding buildings, moving bodies, foliage, etc.), establishing and maintaining a stable communication link with UE can be difficult, especially when the UE is moving around.

Millimeter wave 5G performance may fluctuate wildly over time and from one location to another, reaching as high as 2 Gbps but sometimes dropping quickly below 4G throughput and, at times, to nearly zero (in 5G “dead zones”). The present disclosure identifies UE-side factors that have an effect on throughput and decomposes these into quantifiable factors that can be used to predict UE mmWave throughput and to optimize throughput as a function of the UE-side factors.

In some examples, a 5G throughput map depicts not only 5G coverage but also feeds variegated throughput performance information to mobile applications executing on the UE over time. In some example approaches, the system captures and incorporates key impacting factors specific to a user's environs and context in the form of downloadable ML models. Such a throughput map augmented with the ML models may then aid a 5G-aware throughput prediction application to, e.g., select the initial bitrate for video streaming, and predict future throughput for rate adaptation. Although 5G deployment is still in its infancy, the measurement findings and tools developed may be incorporated in user-side systems and apps, making them 5G-aware. While the discussion below focusses on the user side, the findings and ML models may also be used to help 5G carriers in improving their 5G services.

In the example shown in FIG. 1, a system 100 for predicting user equipment 5G throughput includes one or more items of user equipment 102 communicatively connected to a computing system 104. Computing system 104 includes a machine learning engine 112 and training data 114 used to train machine learning engine 112 to create a machine learning model capable of predicting 5G throughput. UEs 102 are also configured to communicatively connect to one or more cellular nodes, such as 5G panels 106A and 4G towers 106B (collectively “cellular nodes 106”). In the following the term “5G panel” is used to describe a particular 5G cellular radio unit. The methodology described below may be applied to any type of 5G cellular radio unit, to base stations and to towers. At the same time, although performance in the following is measured in terms of throughput, other performance parameters may be used, including one or more of the following: download throughput, uplink throughput, signal strength, latency, level of carrier aggregation, type of cellular network (5G-low band, 5G-mid-band, 5G-mmwave, LTE-low band, etc), etc., by applying the same methodology. Finally, as described in mode detail below, performance, no matter the parameter chosen may be predicted both quantitatively (i.e. exact values such as 80 Mbps) and qualitatively (i.e. categorically say as high/medium/low or good/average/bad), since certain applications only decide based on the qualitative level. The thresholds of what performance level is considered high vs. low or good vs bad, etc. can be application specific. For example, a video-on-demand application may have different requirements that, e.g., a video conferencing application or live video streaming. The ML modeling described below does not determine these thresholds, but simply demonstrates the idea to predict both ways (quantitatively and qualitatively) using selected threshold levels.

in One such example, UEs 102 are configured to collect at least a portion of the training data 114 used to train machine learning module 112. The prediction techniques described may also be used to predict parameters such as signal strength (e.g., Reference Signal Received. Power (RSRP) or Reference Signal Received Quality (RSRQ)), level of carrier aggregation (e.g., 1CA, 4CA, 8CA) and uplink throughput. The prediction results may be used in resource allocation and scheduling, or by throughput-aware and signal strength-aware applications executing on user equipment. Further details of the techniques of this disclosure and other aspects of the inventions may be found in Arvind Narayanan, Eman Ramadan, Rishabh Mehta, Xinyue Hu, Qingxu Liu, Rostand A. K. Fezeu, Udhaya Kumar Dayalan, Saurabh Verma, Peiqi Ji, Tao Li, Feng Qian, Zhi-Li Zhang. “LUMOS5G: Mapping and Predicting Commercial mmWave 5G Throughput.” Proceedings of the ACM Internet Measurement Conference (IMC′″20), Oct. 27-29, 2020. Virtual Event, USA. ACM, New York, N.Y., USA, pp. 176-193, https://doi.org/10.1145/3419394.3423629, the descriptions of which are incorporated by reference.

Today's commercial 5G services are deployed in non-standalone (NSA) mode. That is, 5G New Radio (NR) is deployed with its own antennas but shares the 4G packet core infrastructure. As such, 5G “towers” are either co-located with or are close to 4G towers. With NSA, much of the touted 5G benefits come from 5G NR. 5G NR encompasses a wider spectrum than low-band (24 GHz) frequencies. Low-hand and mid-band 5G form the basis of most of today's initial 5G service deployment in the world they offer only moderately higher bandwidth than existing 4G LTE or advanced LTE services.

In contrast, high-band 5G, which covers the mmWave frequency bands offers bandwidth as high as 20 Gbps theoretically, but considerably lower bandwidth in practice. High-band (especially mmWave) 5G radio signals are known to be highly directional, require line-of-sight (LoS), and have limited ranges. Particularly, they are sensitive to the environment and may be blocked by concrete structures, tinted glass, human bodies, and other moving objects.

The commercial deployment of 5G services offers a new opportunity to conduct “in the field” measurement of 5G performance, especially since mmWave 5G is known to be highly sensitive to various radio signal quality impairments and environmental factors. Recent measurement studies of commercial 5G deployment, including mid-band and mmWave 5G services offered by several carriers in the US show that commercial mmWave 5G services may deliver up to 2 Gbps bandwidth per UE, but that performance is subject to various environmental and other factors.

An aspect of 5G performance is the effect of key user-side factors (i.e., features) on mmWave 5G throughput performance. It can therefore be advantageous to build good machine learning models that utilize such user-side features to predict 5G throughput performance. Hereafter when not explicitly stated, 5G refers to mmWave 5G. As noted above, 5G throughput performance may vary widely and wildly from as high as 2 Gbps to as low as close to 0. User mobility and the presence of obstructions exacerbate the problem and may lead to frequent handoffs.

Such high variability poses challenges for applications that rely on the ultra-high bandwidth offered by mmWave 5G eMBB services. It is possible, however, to characterize and map 5G throughput performance, with the goal of identifying the key (especially, UE-side) impact factors and quantifying the (short- & long-term) predictability of 5G throughput performance via repeated experiments. To understand their potential impact on 5G throughput, in one example approach, several UE-side factors were identified and decomposed into quantifiable factors, conducting empirical and statistical analysis over the factors individually to understand their impact on 5G throughput behavior and its predictability. 5G throughput performance is driven by a wide spectrum of factors; their interplay is much more complex compared to traditional cellular technologies such as 3G and 4G.

5G throughput mapping is important. Signal strength, spectrum and channel state measurements have been widely studied in wireless and cellular networks, many from the perspective of a cellular provider, e.g., for 3G/4G cellular channel scheduling. High-band (especially mmWave) 5G radio signals are known to be highly directional, require line-of-sight (LoS), and have limited ranges. Particularly, they are sensitive to the environment and can be blocked by concrete structures, tinted glass, human bodies, and other moving objects. Studies have shown that even in the case of 3G/4G networks, location alone cannot provide a good prediction of signal strength or throughput. As confirmed by our measurement results, there are far more factors affecting 5G performance. In one example approach, a measurement platform (an app) that can run on 5G mobile handsets was designed to directly measure 5G throughput. The ability to predict 5G throughput with a reasonable accuracy can help improve transport-layer mechanisms needed to address new challenges posed by 5G. It can also benefit many applications, e.g., adaptive video bitrate streaming. For example, given a prediction error ≤20%, the QoE of adaptive video streaming may be improved to close to optimal (>85)%. Such an ability is more critical to emerging 5G eMBB applications that require ultra-high bandwidth. Conventional methods adopted by applications for throughput estimation and prediction have been mostly “in situ;” that is, the applications either use past data transmissions or generate a few probes to estimate and predict (immediate) future throughput. Sonic such approaches also heavily rely on having access to PHY-layer information. However, to address modern-day security concerns, mobile OS developers have increasingly started to restrict third-party app developers from having access to OS-level APIs which earlier provided easy access to low-level PHY-layer information.

In order to predict 5G throughput with a reasonable accuracy, it is also important to capture and account for various environment, contextual, and other exogenous factors. Conventional methods may, therefore, be inadequate for 5G applications to estimate throughput performance. In fact, even the combination of a carrier's 5G coverage map and of 5G coverage mapped by us to show the percentage of 5G connectivity were insufficient to understand 5G throughput. 5G throughput maps may be built based on user-led (collaborative) 5G throughput measurement data. Such throughput maps not only show 5G coverage and depict 5G throughput variability over time and across different locales, but more importantly, they also incorporate mmWave-specific environmental and contextual factors (in the form of ML models) to help apps better utilize 5G's high-throughput.

For a long time, ML has been used for throughput prediction not only in wireless networks but also in wired networks. Indeed, due to the vagary of wireless signals and the recent advancements in ML, data-driven machine learning (ML) models have become popular for 3G/4G cellular network management. Given the diverse array of impact factors and their complex interplay, the need for ML models for 5G networks is even more acute. However, it is not sufficient to blindly applying machine learning to the problem of 5G throughput prediction. Instead, it is necessary to answer a few basic questions:
(i) Is mmWave 5G throughput predictable, and to what extent?
(ii) What key UE-side factors (or features) most affect 5G throughput?
(iii) What types of ML models are best suited for 5G throughput prediction based on key UE-side factors?

It is possible to develop ML models that are explainable. To this end, measurements were designed under various settings (e.g., selecting indoor and outdoor areas, considering both stationary scenarios and mobility scenarios of various moving speeds), conduct extensive and repeated experiments for data collection, throughput characterization and factor analysis, and apply empirical and statistical analysis over the factors individually to determine their impact on 5G throughput behavior and its predictability.

The measurement findings were used to develop a holistic and robust ML framework that predicts 5G throughput both qualitatively (via classification) and quantitatively (via regression). Our framework is “composable” in that it judiciously considers different feature groups (geographic location, mobility, tower-based, radio connection) as well as their combinations. The framework achieves accurate and reliable 5G throughput prediction. Furthermore, using 5G-specific features significantly improves the prediction results. Powered by judicious feature and ML model selection, the framework achieves an overall weighted average F1 score of up to 0.96 (with three prediction classes), and 1.37× to 4.84× reduction in throughput prediction error compared to existing approaches designed for

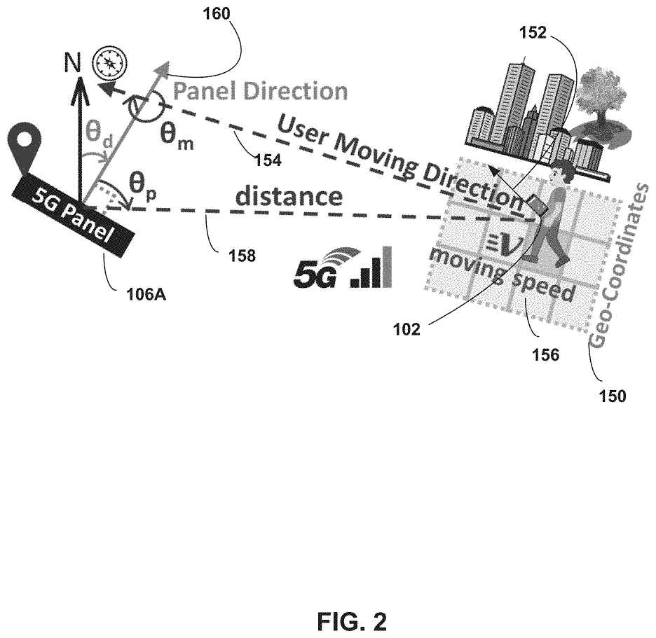

FIG. 2 is a block diagram illustrating the collecting of the training data of FIG. 1, in accordance with one or more techniques of the disclosure. In one example approach, training data 114 includes data such as phone state, service state, and signal strength as measured by UEs 102. In one such example approach, as illustrated in FIG. 2, the training data also includes information such as the UE's geolocation 150, orientation 152 (e.g., compass direction), direction of movement (trajectory) 154, moving speed 156, active radio type (e.g., 5G-NR or LTE), and the identifier (ID) of the current tower (or panel) 106 and information such as the location and orientation of the 5G panel 106 (identified by, for instance, manually surveying the area). The above information may be used to compute additional fields of the UE 102 with respect to each panel 106 to study their impact on 5G throughput and signal strength or on resource allocation and resource scheduling.

As depicted in FIG. 2, the distance between a particular UE 102 and cellular node 106 is shown with the line 158 drawn between UE 102 and cellular node 106 (shown here as a panel 106A). The arrow 160 orthogonal to the surface of panel 106A illustrates the direction the panel 106A is facing with respect to the North pole. UE-Panel positional angle θp is the angle of the UE 102 with respect to panel 106A irrespective of moving direction. UE-Panel mobility angle θm is the angle between the line normal to the front-face of the panel 106A and the UE's trajectory 154. In one example approach, an application running on an Android phone logs this information once per second, parsing raw-string representation of Android's ServiceState and SignalStrength objects to get information about phone state, service state and signal strength.

With the knowledge of the 5G panel location and orientation (identified by manually surveying the area), it is possible to compute additional fields of the UE with respect to each panel to study their impact on 5G throughput. Table 1 lists all the fields recorded by the UE (fields with * with accuracy % provided by Android). Table 2 lists the fields with values obtained after post-processing or from other sources. The values of the fields in Tables I and 2 are used in our subsequent measurement analysis and features for ML.

TABLE 1
Fields Recorded using Android API

| Field | Description |
|---|---|
| timestamp | Logs date and time |
| latitude* | UE's fine-grained geographic coordinates (i.e., |
| longitude* | geolocation) & its estimated accuracy reported by |
| | Android API |
| detected activity* | reports if user is walking, still, driving, etc. |
| | using Google's Activity' Recognition API |
| moving speed* | reports UE's moving speed using Android API |
| compass direction* | The horizontal direction of travel of the UE w.r.t. |
| | North Pole (also referred to as azimuth bearing) & |
| | its accuracy |

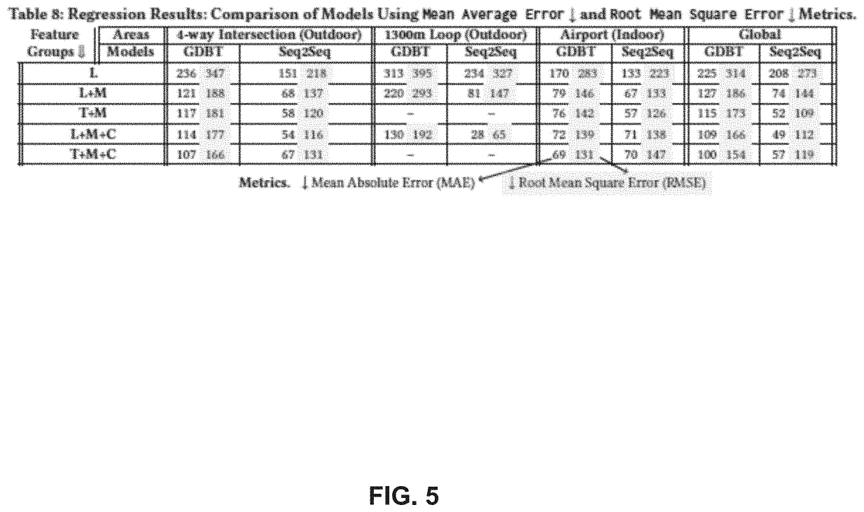

TABLE 2
Fields with Values Obtained after Post-
Processing or from Other Sources

| Field | Description |
|---|---|
| throughput | Downlink throughput reported by iPerf 3.7 |
| radio type | UE connected to 5G or 4G, identified by parsing |
| | it from raw Service State object |
| cell ID | mCid (tow er identity) the UE is connected to, |
| | parsed from raw ServiceState object |
| signal strength | Signal strength of LTE (rsrp, rsrq, rssi) & 5G |
| | (ssrsrp, ssrsrq, ssrssi) respectively, parsed |
| | from raw SignalStrength object |
| horizontal handoff | UE switches from one 5G panel (cellID) to |
| | another |
| vertical handoff | LIE switches between radio type (e.g., 4G to 5G) |
| UE-panel distance | distance between the UE and panel it is |
| | connected to |
| positional angle (θp) | angle between UE's position relative to the line |
| | normal to the front-face of 5G panel (see FIG. 2 |
| | for illustration) |
| mobility' angle (θm) | angle between the line normal to the front-face |
| | of 5G panel and UE's trajectory (see FIG. 5 for |
| | illustration) |

In one example approach, to get the throughput ground truth, the tool measures the bulk transfer throughput over 5G. In one such example approach, iPerf 3:7 is cross-compiled and integrated it into an app such that a UE is periodically downloading content from a backend server. This enables not only the collection of vital statistics about the network state, but also the evaluation of 5G throughput performance under different settings such as mobility mode, geolocation, etc. To ensure full saturation of the available bandwidth provided by the 5G carrier, in one example approach, eight parallel TCP connections were established with the backend server, as the UE was not able to filly utilize 5G's downlink bandwidth using a single TCP connection.

As throughput increases between panel 106 and UE 102, the bottleneck of an end-to-end path between a UE 102 and the backend server (i.e., the content server) may shift from the radio access network or carrier's infrastructure to the Internet. To avoid this and ensure more accurate 5G throughput measurement results, measurements were conducted using a variety of servers hosted by multiple public and private cloud providers at diverse geographical locations. Factors such as server location and cloud service provider were observed to affect 5G performance. Experiments were conducted (at least 5×60-second runs) using servers and then particular servers were selected using the following filtering criteria: (1) downloading from these servers yields the highest 5G throughput (statistically) compared to servers in other locations and/or providers; and (2) downloading from these servers using other wired (nonmobile) hosts yields at least 3 Gbps throughput, well beyond the peak 5G throughput. To confirm the accuracy of the measurements, a commercial Ookla Speedtest tool was used to test the throughput and ensure that their results matched, with a difference less than 5%.

Finally, GPS coordinates, compass direction, and moving speed reported by Android APIs are often inaccurate, especially when fine granularity matters. Hence, direct usage of these values can be misleading. To ensure data quality remained high, multiple measurements were conducted per trajectory on different dates and times of day to ensure the collected data was statistically representative, discarding data where the average GPS error (reported by the Android Location API) was greater than 5 meters along the trajectory, adding a “buffer period” at the beginning of each walk/drive test waiting for the UE 102 to perform GPS/compass calibration, and reducing the localization noise by discretizing raw GPS coordinates to the nearest known (pre-calculated) pixelized coordinates.

In one example approach, the pixel coordinates were defined by Google Maps Javascript API for each zoom level a Google map is viewed at. This helps create a grid over the geographic map, For instance, at zoom level 17, each pixel's spatial resolution ranges between 0.99 to 1.19 meters (or ˜1 meter). In one example study, zoom level was set at 17, providing a nice balance without being overly precise but at the same time representing a geographic location with a reasonable spatial resolution. Pixelized coordinates also helped reduce the sparseness that exists in high resolution GPS-based coordinates. In the rest of this description, geolocation coordinates refer to pixelized (X,Y) coordinates at zoom level 17.

To help understand the issues expressed in FIG. 2, it may be helpful to consider potential use cases of the ML framework when in action. In one example, four users are streaming high-resolution videos on their UE in the same area. Each UE is equipped with a throughput-aware and signal strength-aware application capable of predicting 5G throughput (the “5G throughput prediction app”). Alice is taking a ride inside a taxi, while Bob is walking on the pedestrian street in the same direction as Alice's ride. Charlie is walking on the other side, while Daisy is walking inside the park. Employing their 5G throughput prediction app, each user's UE automatically downloads 5G throughput maps with ML models based on their geographic locations; the video streaming app interacts (via appropriate APIs) with the ML models which take into account the context and various factors such as location, moving speed & direction, type of available service 3 to predict 5G throughput. Accordingly, the app can make intelligent decisions (e.g., bitrate adaptation) to improve user QoE. For instance, user mobility has a significant impact on 5G performance. Hence, Alice who is taking a taxi ride at a relatively high speed should expect to experience degraded performance compared to Bob who is walking along the same trajectory. Similarly, when Charlie is about to walk across a handoff patch (as learned by the model), there will be a momentary degradation in performance which the app can anticipate and prepare for. Daisy who is walking in the park does not have a clear line of sight to the 5G tower; however due to the concrete high-rise buildings around her, signals may reflect back, providing degraded 5G performance. Thus, 5G carriers can incorporate a 5G throughput prediction app and its ML models to supply apps with throughput prediction by considering the key factors based on the user context and aid the other apps on the UE (e.g., service or content provider apps) in making intelligent decisions. UE can also provide feedback information to help carriers in making resource allocation and scheduling decisions based on application needs.

A six-month study of two locations in Minneapolis was performed using 4× Samsung Galaxy S10 5G smartphones. As shown in Table 3, three urban areas were tested for

TABLE 3
Areas Tested

| Area | Intersection | Airport Mall | Loop |
|---|---|---|---|
| Description | Outdoor 4-way | Indoor mall area | Loop with railroad |
| | traffic | with shopping | crossings, traffic |
| | intersection | booths | signals, parks |
| | | | and restaurants |
| Trajectories | 12 | 2 | 2 |
| Trajectory | 232 to 274 m | 324 to 369 m | 1300 m |
| Length | | | |

mmWave 5G coverage: 1) an outdoor four-way traffic intersection in the heart of downtown Minneapolis downtown region consisting of 3 dual-panel faced 5G towers 106, (2) an airport mall inside Minneapolis-St. Paul (MSP) International Airport with two head-on single-panel 5G towers 106 approximately 200 m apart, and (3) a 1300 meter loop near U.S. Bank Stadium in downtown Minneapolis that covers roads, railroad crossings, restaurants, coffee shops, and recreational outdoor parks. These areas are representative as they cover indoor and outdoor environments in an urban setting.

For each area, as shown in Table 3, several trajectories were selected, and multiple walking passes were performed per trajectory (at least 30×). For instance, the 4-way intersection had 12 different walking trajectories. In addition to walking, driving tests were also conduct at the Loop area with speeds ranging between 0 to 45 kmph. The full dataset covered 331 km walking and 132 km driving. A summary of factors affecting 5G throughput and predictability for the Airport Mall is shown in Table 4.

TABLE 4
Effect of UE Factors on 5G Throughput
and Predictability for Airport Mall

| | | | Sp | | |
|---|---|---|---|---|---|
| | CV | Norm | Coeff. | KNN | RF |
| UE Factors | w/std dev | test | w/std dev | w/RMSE | w/RMSE |
| Geolocation | 57.6% | 51.56% | 0.021 | 240 | 228 |
| only | ±22.24 | | ±0.19 | 326 | 313 |
| Geo & | | | | | |
| Mobility: | | | | | |
| UE-Panel | 40.24% | 78.05% | 0.68 | 167 | 135 |
| Distance | | | | | |
| UE-Panel θp | ±20.94 | | ±0.14 | 247 | 201 |
| UE-Panel θm | | | | | |
| Moving speed | | | | | |

In 3G/4G networks, geographic location is the dominant factor for indicating throughput performance or their coverage. However, as shown earlier, our initial experiments on 5G networks indicate that the throughput performance wildly fluctuates even for areas known to have 5G service. Next, the impact of geolocation (i.e., pixelized latitude, longitude information, etc.) on 5G throughput and predictability was studied. For certain patches of the airport mall, 5G throughput was consistently high but, for other patches of the airport mall, 5G throughput was consistently poor due to frequent horizontal and/or vertical handoffs caused by obstructions in and around the environment). And there were patches where the throughput was uncertain.

The throughput differences were quantified across different geolocations, performing pairwise t-test and Levene test of throughput measurements for ever pair of geolocation measurements (or grid) at the airport mall. The p-value results showed that, considering a significance level of 0.1, on average, the mean throughput measurements of 70.86% of geolocation pairs for the mall area differed significantly from each other. These numbers imply that geolocation is one of the key factors to capture throughput differences. Similar results for the pairwise Levene test (64.26%) confirmed this finding. Similar results for the pairwise t-test and Levene test in the 4-way intersection (69.66% and 61.06%, respectively) confirm this finding; for outdoor environments.

As can be seen in Table 4, geolocation information, however, is not enough. The normality test results in Table 4 show that throughput measurements of roughly 48% of geolocations (i.e., almost half the area) at the airport do not follow normal distribution. To reduce the false positives in detecting normal distributions, we used two types of normality tests: (1) the D'Agostino-Pearson test, and (2) the Anderson-Darling, test. The measurements associated with a geolocation were considered as normal if they pass any of the two types. The mean and coefficient of variation (CV) of throughput samples were also calculated at each geolocation. Approximately 53% of geolocations have CV values ≥50%, confirming the observation that 5G throughput varies significantly even at the same geolocation. Indeed, ML models built using geolocation as the only feature (KNN and Random Forest, see Table 4) yield poor accuracy—an average MAE and RMSE of 240 Mbps and 326 Mbps for the KNN model, respectively. The results indicate that geolocation alone is insufficient to characterize or predict 5G throughput.

Mobility direction also affects 5G throughput, Mobility direction was selected as a factor since, unlike omnidirectional signals in 3G/4G, 5G mmWave signals are highly directional, and sensitive to obstructions such as human body or structures. For instance, walking away from a 5G panel will naturally obstruct the UE's line of sight (LoS) to the 5G panel due to user's body, and may require the UE to acquire a non-line of sight (NLoS) reflective path. This can be seen in the Airport mall data. Data representing two walking trajectories: NB (north-bound) and SB (south-bound) was captured. The data captured represented throughput traces collected by walking each of the two trajectories repeatedly for over 30 times. Each of the approximately 340-meter-long walking sessions captured an approximately 200 second throughput trace. The airport mall area was selected because both panel locations were equipped with single-sided 5G panel (unlike dual-panel installations seen in outdoor environments). This ensured that the UE 102 was connected to only one side of the panel 106, demonstrating the impact of mobility direction. 5G throughput maps for trajectories NB and. SB showed that, although NB and SB followed the same path in opposite directions (with partial overlap in their coverage footprints), their heatmaps are highly different, indicating that mobility direction has a significant impact on 5G throughput performance. Similar observations were made in other areas.

To further quantify this observation, Spearman's rank correlation coefficient was used to measure the monotonic trend (i.e., a consistent upward or downward trend) between throughput traces. The average Spearman coefficients of throughput traces belonging to NB and SB were 0.61 and 0.74, respectively. In other words, with values above 0.5, throughput traces in the same direction showed a consistent trend in increase or decrease of throughput values along the trajectory. However, the average Spearman coefficients between throughput traces belonging to different directions was only 0.021. Similarly, 29.76% of geolocations have throughput samples with CV values greater than 50%—a decrease of 23%.

Recall from the analysis in Table 4, the KNN and RF models were built using only the geolocation feature to predict the throughput; they exhibited poor accuracy. Based on those models, by additionally accounting for mobility direction. RMSE was reduced by 24% and 36% for KNN and RF, respectively. The results indicate that in addition to the absolute geolocation, further considering the movement direction leads to improved 5G throughput prediction.

The geometric relationship between 5G panel 106, UE 102, and moving direction 154 was studied next. The study identified three geometric factors: (1) the OF-panel distance, (2) the UE-panel mobility angle (θm), and (3) the UE-panel positional angle (θp) and quantified their impact on 5G throughput. Due to its high frequency, mmWave signals suffer from high attenuation as they propagate. That is, throughput degrades quickly as the distance increases. The detailed, quantitative distance-throughput relationship differs, however, from one location to another due to the environmental impact. For example, the south panel at the airport mall showed that the throughput first (statistically) goes down and then ramps up as the distance increases. This is because there is an NLoS between 5G and 100 m due to obstacles (caused due to open-space restaurants and information booths) in the mall-area. The UE regained LoS beyond 100 m, and the regained throughput outweighs the penalty incurred by the distance increase.

As noted above, the UE-panel mobility angle (θm) is the angle between the line normal to the front-face of 5G panel and UE's trajectory. It represents the UE's movement with respect to the face of the 5G panel. When θm=180°, the UE is moving head-on towards the 5G panel, while θm=0° when the UE is walking along the same direction as the 5G panel's facing direction. Thus, if a UE is hand-held by a walking-user, θm=0° will make the user's body obstruct the LoS between UE and the 5G panel (the case in our experiments), causing performance degradation. This high-level trend was observed in all three areas. Again, however, some geolocations exhibit other behavior. For example, one “outlier” was identified where θm ∈[30°, 75° at the south panel. Despite the user moving away from the 5G panel, throughput remained high. This was likely because the signal was properly deflected by the environment, mitigating any severe performance degradation incurred by NLoS.

As noted above, the UE-panel positional angle (θp) is the angle between the line normal to the 5G panel and the line connecting the UE to the panel. When θp is close to 0° (i.e., the front “F” position), the UE is in front of the panel. When θp is around 180° (i.e., the back “B” position), the UE is on the back side of the panel, creating a NLoS situation leading to potential performance degradation. Similarly, positions left (“L”) and right (“R”) were defined.

A general trend is that the F position of θp exhibits far better performance compared to the L, R, and B positions, in particular when the UE-panel distance is short. There is a subtle difference between θp and θm. A UE with θm=180° need not necessitate that it is in front of the 5G panel. For instance, a UE with θp=180° positioned at the back (“B”) of 5G panel can also have θm=180°. In other words, as shown earlier in FIG. 2, θp differs from θm as the former considers the UE's absolute position instead of its moving direction. Thus, both these angles (θp and θm) coupled with the UE-panel distance is useful in capturing the UE's location from the 5G panel's perspective.

Mobility is a major technical challenge in mmWave 5G due to the physical layer characteristics of mmWave that make its signals fluctuate highly, thus causing wild variations in performance. Experiments were conducted in the wild to investigate the impact of mobility speed on 5G throughput by, for instance, conducting walking and driving tests on the 1300 m Loop area (at least 30× times). For the driving tests, the phone was mounted on the car's windshield while for the walking tests, the phone was hand-held in front of the subject. The area tested was in downtown Minneapolis downtown and included a number of traffic/pedestrian lights, public transit rail crossings, restaurants and bars, high rise buildings, and a public park. Driving speeds on the loop ranged between 0 and 45 kmph while walking speeds hovered between 0 to 7 kmph.

Throughput distributions were recorded at different ground speeds as reported by the Android API, where record represented a one-second sample measured for a given speed. range. Mobility under driving mode was demonstrated to have a significant impact on 5G throughput. Statistically, the throughput decreased as the driving speed increased. Under no-mobility to very low moving speeds (<5 kmph), representing times when the car was about to stop/start or stationary (due to a traffic stop sign or a red light), the throughput peaked at ˜1.8 Gbps with a median throughput of ˜557 Mbps. Beyond 5 kmph, 5G performance showed a huge degradation as the median 5G throughput fell to 4G-like performance, ranging between 164 Mbps and 60 Mbps. At the same time, peak throughput for moving speeds between 5 and 30 kmph were above 850 Mbps, suggesting other factors might still boost the throughput performance.

This was not the case, however, while walking. To investigate further, a side-by-side throughput distribution comparison of walking vs. driving was conducted with a finer-grained speed range of 1 kmph per box. Compared to driving mode, there is little to no significant degradation in 5G throughput for walking as the speed increases. Peak throughput while walking was able to reach high levels of above 1.8 Gbps across the entire range of moving speed (i.e., 0 to 7 kmph). At the same time, the median throughput while walking was consistently better (by 14$ to 457 Mbps) than that while driving. Such poor performance while driving is not surprising as mmWave signals need to reach the UE 102 by propagating through the car's body (e.g., windshields or side windows) and that process attenuates the signal strength, causing throughput degradation. This study showed, therefore, that 5G throughput is affected by a combination of effects reflecting not only by ground mobility speeds but also the mode of transport, further highlighting the complex interplay of factors impacting 5G throughput.

In summary, through in-the-field experiments, it was determined that numerous factors impact 5G throughput: geolocation, mobility direction, UE-Panel orientation, UE-Panel distance, UE's mobility speed, etc.—far more sophisticated than those impacting 4G/LTE. In addition, instead of independently affecting the performance, these factors may cause complex interplay that is difficult to model analytically. Table 4 summarizes the statistical findings and the 5G throughput prediction accuracy using existing models. It clearly shows that an approach that accounts for UE-side mobility-related factors in addition to UE's geolocation is able to better characterize 5G throughput (thus leading to better prediction accuracy) compared to using geolocation alone.

Some of the key considerations and criteria employed for developing ML models in the desired ML framework for 5G throughput prediction will be discussed next. As part of the discussion, the idea of feature groups is introduced to account for diverse sets of impact factors at the UE-side. “Composable” ML models were then developed that employed different sets of features depending on the availability of the features and of usage context.

As discussed above, there are a whole gamut of diverse factors that impact 5G performance, many of them, however, such as e.g., channel state and various radio impairments that may be sensed by the 5G base station, are not readily available to applications running on the UE. Hence the following example approach focuses on UE sidle features that may be measured and collected. In addition, the approach takes advantage of additional features, e.g., radio type, signal strength, handoff information from the PHY layer, when available.

Table 5 is an example of the use of composable feature groups. Feature groups classify similar features into categories. Such an approach offers several benefits. First, it helps account for the collective effects and interplay of similar features. Second, it allows the user to select available and relevant features, and to compose feature sets depending on the usage case (e.g., stationary v/s. mobile scenarios). Finally, it enables the comparison of ML models with different feature combinations to investigate the importance of various feature groups under diverse settings and to develop explainable ML models for 5G throughput prediction.

TABLE 5
Feature Groupings

| Feature | |
|---|---|
| Group | List of Features |
| L | Pixelized Longitude & Latitude coordinates |
| M | UE Moving Speed + UE Compass Direction |
| T | UE-Panel Distance + UE-Panel Positional Angle + UE-Panel |
| | Mobility Angle |
| C | Past throughput measurements + (PHY features: Radio Type + |
| | LTE Signal Strength + 5G Signal Strength + Horizontal |
| | Handoff + Vertical Handoff) |
| L + M | (L) + UE Moving Speed + UE Compass Direction |
| T + M | UE Moving Speed + UE-Panel Distance + UE-Panel Positional |
| | Angle + UE-Panel Mobility Angle |
| L + | (L + M) + Radio Type + LTE Signal Strength + 5G Signal |
| M + C | Strength + Horizontal Handoff + Vertical Handoff |
| T + | (T + M) + Radio Type + LTE Signal Strength + 5G Signal |
| M + C | Strength + Horizontal Handoff + Vertical Handoff |

In the example shown in Table 5, the available features are grouped into four primary feature groups. Group L represents the basic location-based feature group which contains (pixelized) geographic location coordinates. Group M represents the basic mobility-based feature group which includes moving speed and compass direction (i.e., azimuth angle) that can be measured using sensors on the UE. In place of location-based features, Group T represents the (more advanced) tower-based feature group which contains features such as the distance from a UE to the 5G panel, positional (θp) and mobility (θm) angles to the 5G panel (see FIG. 2 for illustrations). These features can be collected by the UE but rely on exogenous information obtained, i.e., via the 5G tower location/direction information either measured by us or supplied by the carrier. Despite that, ML models trained using these features are likely more transferable to other areas with similar geolocation characteristics as the features do not depend on the absolute locations of the UEs, i.e., being location-agnostic. Group C represents the connection-based feature group which includes, e.g., (the immediate) past throughput values measured by an application and or various low-level PI-TY-layer features provided by the UE, when available.

Next, in the example shown in Table 5, four feature group combinations are shown. Each feature group includes two or more of the primary feature groups: (i) L+M (the Location+Mobility model); (ii) T+M (the Tower+Mobility model); (iii) L+M+C (the Location+Mobility+Connection model); and (iv) T+M+C (the Tower+Mobility+Connection model). These four combinations were selected to compare the performance of ML models using different feature groups under mobility scenarios, and to study the feature group importance in 5G throughput prediction. ML models with and without connection-based features were considered for different use cases as connection-based features require a 5G connection to be established for collecting measurement data. ML models without connection features are still useful, for example, for initial bitrate selection in adaptive video streaming.

In addition to the above four combinations, other feature group combinations may be used to support other usage scenarios. Other primary feature groups may use, for example, “static features” containing information about the UE device model and specifications that are also important for 5G throughput prediction.

ML models will be discussed next. In many settings, it is interesting to know the “level” or range of throughput a user may receive, e.g., low throughput (e.g., 100 Mbps)) or high throughput (e.g., 700 Mbps and above) or somewhere in between, given her current location and usage context. This reduces the 5G throughput prediction problem to a classification problem: given a set of features/feature groups, predict the level of 5G throughput a user can be expected to receive (similar to the signal bars on a cellphone). This information can be used, e.g., for initial bitrate selection for various applications. Three throughput classes were considered: low (below 300 Mbps), medium (from 300 Mbps to 700 Mbps), and high (above 700 Mbps).

In other settings, UE 102 may have access to, e.g., a trajectory of along a route. Given such data, UE 102 may predict the expected throughput value at the next time slot (e.g., 1 second) or the next k time slots (e.g., 30 seconds). Regression-based 5G throughput prediction may aid many applications in making fine-grained decisions in the duration of an ongoing session, e.g., to predict and select the quality levels for adaptive video streaming.

Furthermore, in the examples discussed above, throughput prediction is short-term, i.e., in the time scale of seconds; the models use current (or recent past) measured feature values to predict the immediate future throughput. Such short-term prediction is most useful for dynamic application decision making; ML inference may, therefore, be selected to be relatively light weight. For general 5G throughput mapping, however, longer-term prediction problems (e.g., in the time scales of minutes, hours, or even days) are relevant. Longer-term prediction allows the designed to employ more datasets and devote more computation resources for training and inference, which can be valuable for network management and planning applications, among others.

In one example approach, two classes of ML models are considered, one based on a classical machine learning method—gradient decision boosted trees (GDBT), and the other based on a deep learning technique sequence-to-sequence (Seq2Seq), which is particularly suited for time-series/trajectory-based regression problems.

GDBT ML Models. Gradient boosting is a class of ML algorithms that produces a strong prediction model in the form of a weighted combination of weak learners which optimize a differentiable loss function by gradient descent in functional space. It follows an additive multi-stage approach in which weak learners are added one at a time and gradient descent procedure is used to minimize the loss when learners are added. The weak learners are typically depth-bounded decision trees. GDBT was chosen for several reasons. First, it is lightweight, requiring little computation power. Second, it is composable, allowing different sets of features and feature groups to be easily added and combined as weak learners. Third, it can be used for both classification and regression. Fourth, it is interpretable as its predictive power has strong mathematical justifications and provides us with the ability to compute and analyze the (global) feature importance. Finally, it outperforms other classical machine learning methods such as Random Forest (RF) and k-Nearest Neighbors (KNN), which have been proposed in the literature for 3G/4G signal strength/bandwidth prediction problems,

Seq2Seq ML Models. Initially devised for natural language processing and machine translation, Seq2Seq learning has now become ubiquitous for solving various high-dimensional time series prediction problems. Unlike standard long short-term memory (LSTM) models, Seq2Seq allows us to model an arbitrary length of the predicted output sequence instead of an immediate one-time prediction, thus capable of predicting over a longer horizon into the future. Formally, let Xt={x1, x2, . . . , xt} be a sequence of inputs known a priori at time t where each xt is a feature vector.

Let Yt={y1,y2, . . . ,yk} be a sequence of k outputs to be predicted. In our case, Yt is a sequence of future throughput values to be predicted over the future k time slots. The time slots are defined based on the prediction problem at hand (e.g., seconds for short-time prediction, or minutes or hours for long-term prediction).

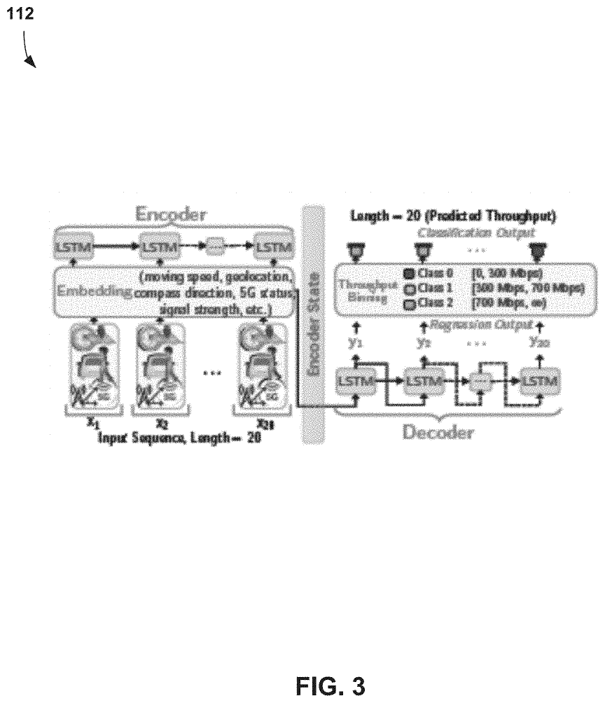

FIG. 3 illustrates an example of the machine learning system of FIG. 1, in accordance with one or more techniques of the disclosure. In one example approach, machine learning engine 112 incorporates an encoder-decoder architecture into the Seq2Seq ML Model using an LSTM-type network, as shown in FIG. 3. In some such example approaches, the models work with different feature groups represented as a sequence of high-dimensional inputs,

The performance of GDBT and Seq2Seq models was evaluated using different feature groups and their combinations. The performance of the selected models was also compared to the performance of other analytical and ML models proposed in the literature for 3G/4G signal strength/throughput prediction.

The evaluation framework used will be discussed next. In one example approach, a grid search was performed for tuning the hypetparameters for both Seq2Seq and GDBT models using throughput traces representing a new area (thus not part of the training or testing data). Although the models were fairly robust to multiple hyperparameter values, a set was selected that provided best performance. For one example set of GDBT models, a gradient boosting regressor (and classifier) with 8000 estimators, bounded by depth of size 8 and with 0.01 learning rate was used. For one example set of Seq2Seq models, a two-layer LSTM Encoder-Decoder architecture with 128 hidden units we used.

In one example approach, Seq2Seq experiments ran for 2000 epochs, where the batch size was set to 256. The input and output sequence lengths were set to be 20. In one such example, the hyperparameters were kept fixed throughout all the experiments. To obtain classification results, during postprocessing, predicted throughput was additionally associated with throughput class. For both GDBT and Seq2Seq, datasets were randomly split using a 70/30 ratio for training and testing, respectively.

In one example approach, mean-squared-error (MSE) was used as the loss function. All experiments were run on a single machine with an Intel Core i7-6850K (12-core) CPU and 2× NVIDIA TITAN V GPUs. Time to train each of the Seq2Seq and GDBT models varied depending on the area and its dataset size. The number of data points representing each area were governed by the trajectory length (see Table 2 for details). In our experiments, Seq2Seq took 6 to 44 hours to train each model while GDBT was comparatively much quicker, taking only 10-30 minutes.

Evaluation Metrics. Regression was evaluated using standard metrics—Mean Average Error (MAE) and Root Mean Squared Error (RMSE). For classification, the weighted average F1 score was considered as the main metric for evaluation. In addition, recoil was used to evaluate the low-throughput class (i.e., below 300 Mbps) prediction. Recall is defined as True Positives/(True Positives+False Negatives). The rationale of using recall for the low-throughput class is that misclassifying low-throughput as high-throughput may often times incur more QoE degradation (e.g., a video stall) compared to misclassifying high-throughput as low (e.g., only video quality degradation without a stall). Therefore, in most cases, the low-throughput class should receive a high recall value.

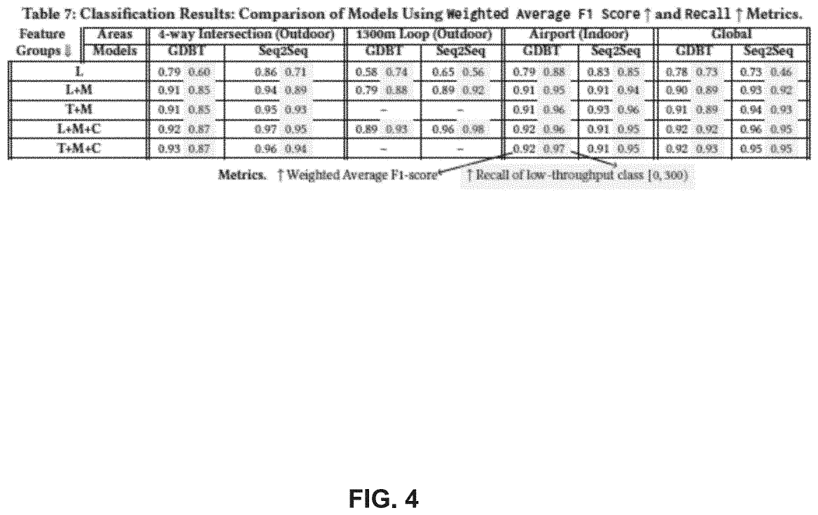

FIG. 4 illustrates the classification results for both GDBT and Seq2Seq models under different feature groupings, in accordance with one or more techniques of the disclosure. FIG. 5 illustrates the regression results for both GDBT and Seq2Seq models under different feature groupings, in accordance with one or more techniques of the disclosure. In one example approach, datasets collected from the three test areas mobility scenarios are used for training and testing (stationary+walking for 4-way Intersection & Airport Mall, stationary+walking+driving for the 1300 m Loop) are used for training and testing, a model was also built by combining data from all areas with known 5G panel locations into a single dataset—referred to as Global. In the case of GDBT, the prediction is based only on the current feature values, whereas in the case of Seq2Seq, recent feature history values (i.e., a sequence of feature values) are used for prediction. The classification results of each model in the table of FIG. 4 contain two values in each cell: the weighted average F1-score and recall of low-throughput class [0, 300) Mbps—as indicated at the bottom of the table. For 1300 m Loop, no results are reported for T+M and T+M+C, as reliable the 5G panel location information was difficult to obtain.

In the table in FIG. 5, the regression results of GDBT and Seq2Seq models over all the areas are shown. Regression prediction plots for L+M+C feature group on Global dataset using GDBT and Seq2Seq, with ±200 Mbps error bounds shaded, showed slightly better prediction results for the Seq2Seq model versus the GDBT model.

The results in the tables shown in FIGS. 4 and 5 clearly demonstrate that both Seq2Seq and GDBT are able to achieve overall good prediction results, especially under feature group combinations that account for UE-side features beyond geolocation. As noted previously, location-based feature group alone is inadequate to achieve high prediction accuracy, especially under high mobility. By combining additional features from mobility and/or connection-related feature groups, the weighted average F1 scores for both GDBT and Seq2Seq throughput class predictions are consistently above 0.89 except for one L+M result for GDBT at the Loop area. The Seq2Seq model produces slightly better prediction results over GDBT for two possible reasons: (i) in the case of throughput class prediction, Seq2Seq uses a sequence of past feature values, which indicates the benefits of incorporating history data for prediction; and (ii) as an LSTM-based general-purpose encoder-decoder, Seq2Seq is known to have stronger representation power compared to GDBT. This is best demonstrated in the regression results shown in the table of FIG. 5, where for most cases Seq2Seq has far lower MAEs and RMSEs.

Furthermore, comparing feature groups L+M vs. T+M and L+M+C vs. T+M+C, the prediction results obtained using tower-based (T*) features, which are location-agnostic, match those using location-based (L*) features. A key advantage in using the T-based feature groups is that ML models trained on one area may potentially be transferable to another area if both share similar environments. To demonstrate that, at the Airport mall area, using the data collected from UEs connected to North panel, a T+M model was trained. The model was then used to test the features associated with the South panel. A decent weighted average F1-score (w-avgF1) of 0.71 was received for the South panel. When the UE-Panel distance is less than 25 m, the w-avgF1 further increases to 0.91, as there exists high environmental similarity between the North and South panels within this range.

Finally, GDBT's capability to report the global importance of features was used to understand how each individual feature contributed to the final prediction outcome. Overall, no single feature or feature group alone dominates in predicting 5G throughput.

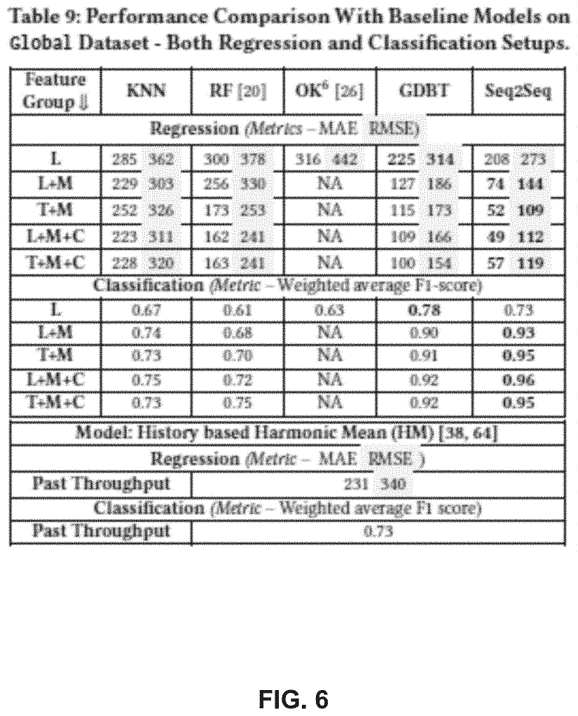

FIG. 6 provides a performance comparison of baseline models with the GDBT and Seq2Seq models under different feature groupings, in accordance with one or more techniques of the disclosure. The performance of the ML models discussed above was compared to sonic of the baseline models that have been proposed in the literature for 3G/4G performance prediction: (1) Classic ML: Random Forest (RF) or KNN; and (2) Analytical: Ordinary Kriging (OK) or Harmonic Mean (HM). While HM is used for short-term predictions, the others have been used in the short and long-term prediction contexts.

To compare classification-based models, weighted average F1-score (w-avgF1) was again used as the metric, while MAE and RMSE were used for regression. All the data was combined (i.e., using the Global dataset discussed earlier) and our models were evaluated against these baselines. Table 9 in FIG. 6 shows a summary of the results. The results clearly show the superiority of GDBT and Seq2Seq models over the baseline models across all the feature groups. For instance, the selected regression models were able to achieve 27% to 79% reduction in MAE, while the selected classification models show an improvement of 9% to 37% in the weighted average F1-score.

Comparisons of performance of the GDBT and Seq2Seq models to existing approaches in different areas using feature groups achieved similar results. Approaches using naive location-based models (L) and spatial interpolation methods (OK) perform poorly compared to our models which account for mobility and connection information. Models based on GDBT and Seq2Seq achieve 16% to 113% higher w-avgF1 than pure-location models based on the Kriging method and achieve 5% to 88% higher w-avgF1 than pure-location based KNN and RF models. This shows the importance of mobility and connection features for 5G throughput prediction.

Furthermore, history-based models such as Harmonic Mean (HM)—that typically use the immediate past throughput observations to make future predictions in real-time—suffer when applied to mmWave 5G due to the wild and frequent fluctuations in mmWave 5G throughput. The superiority of the ML frameworks described above mostly stems from two reasons: (1) judicious feature selection by considering diverse impact factors affecting 5G throughput, and (2) the expressiveness of the ML models themselves, e.g., the “deep” nature of the Seq2Seq model, as noted above. Our results clearly indicate the superiority of both Seq2Seq and GDBT models over existing throughput prediction methods.

The above prediction framework may be extended from download throughput to other cellular performance metrics, including signal strength, latency, level of carrier aggregation, type of cellular network (5G-low band, 5G-mid-band, 5G-mmwave, LTE-low hand, etc.), uplink throughput, RTT, and handover events, based on the same methodologies. The framework may be extended to support inferences with missing features through, for example, Multivariate Imputation by Chained Equation (MICE) and stochastic regression imputation.

Second, the current prediction framework requires “big data” and extensive offline training. In one example approach, the ML framework supplements the data by leveraging lower-layer information. For example, physical-layer events such as beam forming may be used as an indicator of environmental changes, while cellular CQI+DTX information may be used to quickly estimate the link quality & capacity. In one example approach, the ML leverages existing PHY-layer studies to reduce the data requirement of building the prediction model.

Third, the ML framework may be extended to consider tower-side congestion, which may become more of an issue when 5G has a larger user base. In one such example approach, the ML framework distinguishes between environment-incurred vs. congestion-incurred performance degradation. For the latter, the ML framework infers the tower-side overload through decoding control-plane messages broadcast by the base station, such as the Common Control Channel (CCCH), which is used for transmission of control information to devices with respect to random access.

Fourth, accelerating training and inference may be used. For example, a large training task may be divided into training multiple submodels, each corresponding to a small geographical region, with the region size judiciously chosen. Training multiple submodels can be parallelized and doing so can also speed up online inference. The 5G prediction service may, in some approaches, be incrementally rolled out as training data accumulates. If there is no data/model for a specific region, the edge may fall back to using traditional (short-term) prediction methods such as simple weighted moving average.

As noted above, 5G in all its forms may be used to support throughput of up to 20 GbPS—a 100+ improvement compared to today's 4G. This is achieved by a series of innovations including millimeter wave, massive MIMO, advanced channel coding, and scalable modulation. To fully unleash the power of 5G, most of the above applications should ideally be supported by edge computing. Edge computing brings computation and data storage closer to end hosts (e.g., mobile devices, autonomous vehicles) to reduce the response time, so that the wide-area. Internet is less likely to become the performance bottleneck. 5G offers a desirable communication channel over the “last mile” between client devices and edge nodes.

Despite the potential, there remain several major challenges of leveraging commercial 5G networks to boost the service quality and resource efficiency of edge computing. First, at the physical layer, 5G uses two frequency ranges: sub-6 GHz range and mmWave range. Sub-6 GHz or mid-band frequency (1-6 GHz) 5G provides a “middle-ground” solution for initial 5G service deployment. With radio signals largely remaining omni-directional, its potential speed is much slower than mmWave. In contrast, 5GmmWave radios operate at high frequencies of 24 to 53 GHz with abundant free spectrum. mmWave 5G is therefore lightning-fast and is considered to be the dominant technology of 5G in the long term. On the negative side, mmWave signals propagate in a pseudo-optical manner, and are vulnerable to attenuation and blockage despite the beamforming algorithm that attempts to “recalibrate” the radio beam by seeking for a reflective non-line-of-sight (NLoS) path. This makes its performance highly fluctuating in real-world environments, severely hurting the service quality of edge computing systems.

Second, cellular interfaces incur high energy consumption. For 3G/4G radios, their energy drain accounts for ⅓ to ½ of the overall energy consumption of a mobile device (e.g., a smartphone). The corresponding portion for 5G is even higher.

Finally, 5G enables numerous emerging applications that incur high complexity (e.g., volumetric video) or high-performance requirements (e.g., autonomous driving), compared to applications supported by 4G. When using edge to support/enhance these applications, the solution space may further inflate, leading to complex tradeoffs between computation and network resource utilization. How to balance such tradeoffs in a principled manner by judiciously determining offloading, or not, what to offload, and how to offload is a very challenging problem involving multiple entities in the 5G ecosystem, i.e., remote servers(cloud), edge nodes, client devices, the Internet, the 5G networks, and sophisticated application logic.

A data-driven approach for predicting 5G performance is described above. The approach operates by constructing a performance model using a wide variety of carefully selected, robust, and easy-to-collect features. Such a data-driven approach may be used to automatically model the complex relationships between the device's various “contexts” and network performance, in particular for the environment-sensitive mmWave 5G radio. The prediction framework creates a high-resolution 5G “performance map” that acts as a fundamental infrastructural service for 5G edge computing.

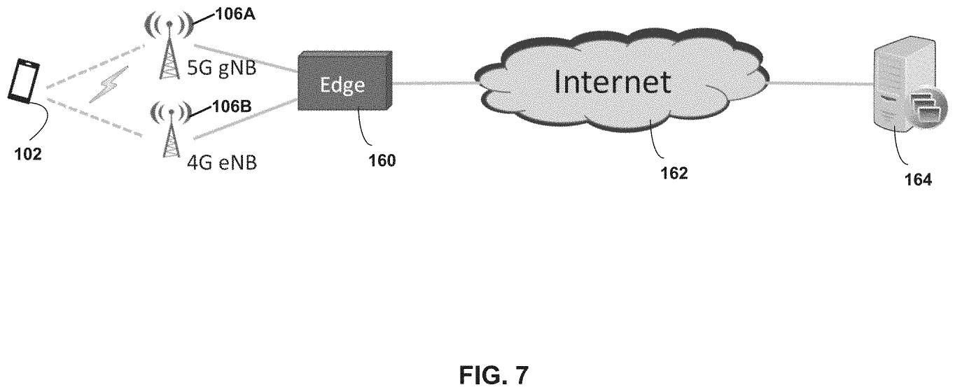

FIG. 7 illustrates an edge computing system, in accordance with one or more techniques of the disclosure. In the example shown in FIG. 7, one or more edge nodes 160 are connected through cellular nodes 106 to UE 102. Edge nodes 160 are further connected through a wide area network 162 such as the Internet to one or more remote servers 164, such as cloud servers. In one example approach, smart multipath is used over 5G node 106A and 4G node 106B to improve download and upload performance at UE 102. In another example approach, smart edge offloading and AI-guided transcoding over 5G are used to improve download and upload performance at UE 102.

In smart multipath, UE 102 adaptively augments 5G using slower but more reliable 4G LTE networks (or other wireless technologies such as WiFi) when needed. In some example approaches, smart multipath may ensure reliable edge offloading with certain guaranteed network performance. With a cross-layer nature, the smart multipath solution may include of a transport-layer multipath scheduler and application-layer data refactoring scheme. They jointly make judicious multipath decisions by considering the heterogeneous performance of 5G/4G networks, their diverse energy characteristics, and application semantics.

Smart edge offloading considers, at runtime, a variety of factors, such as 5G/4G performance, 5G/4G radio energy consumption, application workload, available computation resources, and application quality-of-experience (QoE) requirements. Based on such information, the framework intelligently determines whether to offload, what to offload, and how to offload, in order to balance critical tradeoffs between application QoE and resource consumption (bandwidth, computation, and energy).

In one example approach, Mobile Multipath (MMP) is used to allow applications to simultaneously utilize multiple wireless paths such as WiFi and cellular. In 5G, MMP is even more important due to two reasons. First, compared to a 4G eNodeB, a 5G gNodeB's coverage is much smaller. This will cause frequent 5G-5G and 5G-4G handoffs in particular during mobility scenarios. Second, even when the device is stationary, a temporary blockage may trigger a 5G-4G handoff. During a handoff, the network performance may suffer significant degradation or even “blackout” periods.

By accessing a different network such as 4G or WiFi, a device can effectively use the alternate network as a “shield” that provides basic connectivity. MMP allows smoothly migrating a TCP/QUIC session from one network to another network even before a handoff occurs, thus mitigating the throughput fluctuation and eliminating the blackout. The second reason why MMP is important in 5G is that even when the 5G connectivity is retained, its performance may degrade due to a wide variety of reasons such as congested gNB and poor indoor penetration. In this case, augmenting 5G using 4G or WiFi will also boost network performance.

In one example approach, an Edge MMP solution is deployed at the client device and the edge, while maintaining transparency to remote cloud servers. The Edge MMP solution includes two major components, one operating at the transport layer and the other at the application layer. They provide orthogonal functionalities without and with application-layer semantics, respectively, to achieve robust MMP communication between the client and edge.

At the transport layer, the focus is on improving the scheduler design. As the most important component of MMP, a scheduler determines which path(s) to use and how to distribute the traffic over the path(s). The default MPTCP scheduler (minRTT), which always selects a path with the lowest RTT (as long as the congestion window permits), is known to suffer from major limitations such as severe packet out-of-order and excessive delay when the paths are heterogeneous and high radio energy consumption.

In one example approach, the Edge MMP scheduler is adaptive to the heterogeneous link characteristics of 4G and 5G. For example, to combat the randomness and fluctuation of the mmWave 5G link, the scheduler may, in sonic approaches, choose to strategically inject redundant data (e.g., through forward error correction) over 5G.

In another example approach, the Edge MMP scheduler makes decisions based on the energy profile of both 5G and 4G. The radio power characteristics of 4G and 5G radios are very different. For example, for downlink user data transmission at a high rate, using 5G is more energy-efficient, while for downlink user data transmission at a low rate, using 4G is more energy-efficient. That is, the amount of traffic (i.e., using which paths) and distributing how much traffic to each path) should thus be judiciously made according to the traffic workload and the paths' energy profiles.

In yet another example approach, the scheduler leverages the 5G performance prediction framework described above to make more informed scheduling decisions. For example, 4G is used proactively when a handover, which incurs severe performance degradation is predicted over 5G, is imminent.

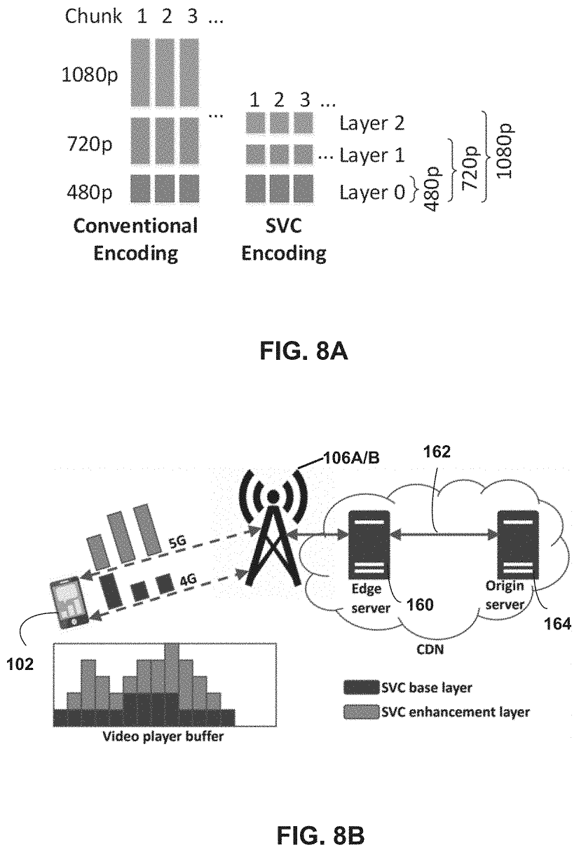

FIGS. 8A and 8B illustrate leveraging application semantics at the application layer to intelligently deliver content over different types of cellular nodes, in accordance with one or more techniques of the disclosure. In the example shown in FIG. 8B, one or more edge nodes 160 are connected through cellular nodes 106 to UE 102. Edge nodes 160 are further connected through a wide area network 162 such as the Internet to one or more remote servers 164, such as an origin server. In one example approach, application layer improvements to smart multipath are used over 5G node 106A and 4G node 106B to improve download and upload performance at UE 102.

In one example approach, application semantics are exploited to refactor data into finer-grained (sub-)streams or objects of different utilities. Generally speaking, when 5G performance is deteriorating, high-importance data may be reliably transmitted over 4G to guarantee the basic performance, and low-importance data may be opportunistically transmitted over 5G to allow improved data quality. The exact data refactoring policy is determined by the application and executed through well-defined interfaces provided by the operating system.

The example of video streaming is used in FIGS. 8A and 8B to illustrate the above idea. In today's video streaming applications, each video is first segmented into chunks (e.g., of several seconds), which are then encoded independently with different quality levels (and bit rates), see conventional encoding in FIG. 8A; and an (application-layer) bitrate adaptation algorithm dynamically decides the quality level of a chunk to be fetched based on the estimated network bandwidth. If a chunk arrives too late, it either causes a stall, or worst, may be discarded (e.g., in live video streaming), wasting the radio resources spent on its delivery. Instead, scalable video coding (SVC) as shown in FIG. 5A, is used to transfer such data more effectively. SVC encodes each video or video chunk progressively into layers (FIG. 8A): a layer-i video chunk is only of utility to the application if layers 0 to i-1 have also been received. The benefits of SVC are best realized when multiple video layers are transported simultaneously over the air by intelligently matching networks of diverse characteristics (e.g., 4G vs. 5G), with data substreams of differing importance. For example, the base layer (i.e., Layer 0) and enhancement layers could be delivered over 4G and 5G, respectively. In this manner, 4G ensures the timely delivery of the base layer chunks, thus minimizing the stalls; 5G allows to opportunistic transmission of the enhancement layers to upgrade the content quality if possible.

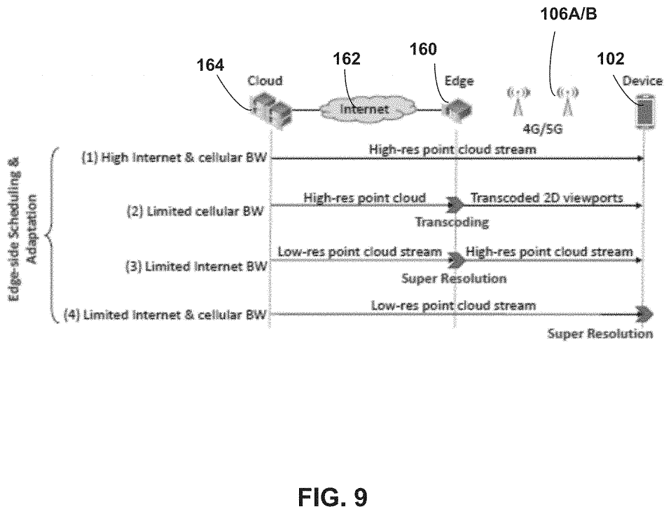

FIG. 9 illustrates smart edge unloading, in accordance with one or more techniques of the disclosure. At runtime, the framework for smart edge offloading over 5G considers a number of factors, such as 5G/4G performance, 5G/4G radio energy consumption, application workload, available computation resources, and application quality-of-experience (QoE) requirement. Based on such information, the framework intelligently determines whether to offload, what to offload, and how to offload, to balance critical tradeoffs between application QoE and resource consumption (bandwidth, computation, and energy). The core scheduling and adaptation logic runs on edge node 160.

In one example approach, leveraging the edge support, radio-aware, multi-stream data adaptation and dynamic transcoding is used to intelligently deliver data. As discussed in the video streaming example above, video data is refactored into layered (sub)streams. Edge node 160 includes intelligent layer selection algorithms for selecting how many layers should be delivered to UE 102 using predicted future available networks (4G/5G), radio bands, and other resources (e.g., available computation resources). Furthermore, instead of fixing the number of layers and bit rates for each layer, edge node 160 dynamically transcodes the data streams by varying the number of layers and bit rates. For example, when Alice is watching a UHD video stationary with good LoS (line-of-sight) beams, the edge may encode the content with only two layers with a far “fatter” base layer that matches the bandwidth of LoS beams, and “thinner” enhancement layer for NUS (non-line-of-sight) beams; when Alice is moving, more layers with lower bit rate each may be used based on the predicted network condition and mobility.

In another example approach, Super-resolution (SR) is used for “upsampling” and AI-aided dynamic data recovery. In one such example approach, computer vision techniques are used to “upsample” received lower resolution videos to higher resolution videos. AI-guided transcoding enables flexibly trading computation resources for network resources, thus significantly boosting the robustness and resilience of the edge computing framework.

In another example approach, edge node 160 exploits the inherent patterns and redundancy in the data and uses AI-aided techniques for lost data recovery, instead of introducing redundancy as in traditional FEC schemes (e.g., fountain code) or relying on retransmissions. These intelligent application adaptation mechanisms are particularly important for latency-sensitive applications. For example, in a dense edge-assisted vehicle-to-everything (V2X) deployment scenario, edge node 160 may support a large number of data transfers among the infrastructure, vehicles, and other devices for various V2X operations. In particular, edge node 160 may reserve for V2X safety services certain ultra-low-latency and high-reliability channels, whose utilization efficiency may be drastically improved by AI-aided coding. Edge node 160 provides an ideal place to execute the abovementioned transcoding and loss recovery logic.

In the example shown in FIG. 9, edge node 160 is used to provide edge-assisted volumetric video streaming. Volumetric video is an emerging type of immersive media content. Unlike traditional videos and 360° panoramic videos that are 2D, every frame in a volumetric video consists of a 3D scene represented by a point cloud or a polygon mesh. The 3D nature of volumetric video content enables viewers to exercise six degree-of-freedom (6-DoF) movement: a viewer can not only “look around” by changing the yaw, pitch, and roll of the viewing direction, but also “walk” in the video by changing the translational position. This leads to a truly immersive viewing experience. As a key technology of realizing telepresence, volumetric videos have registered numerous applications in remote collaboration, education, entertainment, advertisement, journalism, to name a few. Compared to conventional videos and 360° videos where a plethora of studies have been conducted, research on volumetric video streaming is still at an early stage. How to efficiently deliver volumetric videos that consist of a stream of 3D scenes, in particular over bandwidth-constrained networks to commodity client hosts, remains an unsolved issue. A key challenge is that, streaming high resolution volumetric videos over the network is extremely bandwidth hungry. Hundreds of Mhps or even Gbps of bandwidth is required to stream high-quality encoded volumetric videos, such that even 5G may fall short of reliably supporting such high data rates.

FIG. 9 illustrates four methods for realizing volumetric video streaming may be realized: (1) when both the Internet and cellular networks have high bandwidth, the remote cloud can directly stream high-resolution volumetric content to the client device without assistance from the edge.

(2) When the Internet has good network condition while the performance over the cellular path degrades, the edge can render and transcode the 3D volumetric content into 2D views appearing in user's viewport, based on the real-time viewing position and direction of the user. This will drastically reduce the bandwidth utilization over the last mile at the cost of reduced content quality.

(3) If the Internet-side performance degrades while the cellular-side performance remains good, the edge can fetch low-resolution content from the cloud server and then perform super-resolution (SR). Recall that SR is a class of techniques that enhance the video/image resolution typically through machine learning. If properly applied, SR can drastically reduce the bandwidth consumption (at a given video quality) or increase the perceived quality (for a given bandwidth budget) of Internet videos by using computation to trade for the scarce network resource. SR was initially designed for improving the visual quality of 2D images and videos. It may be used in volumetric video streaming, as every frame of a volumetric video is a point cloud (or a 3D mesh).

(4) If both the Internet and cellular networks experience poor performance, the SR could be “onloaded” to client devices. A challenge here is that the computation overhead of 3D SR is very high, making it difficult to be executed on commodity devices.

The four schemes illustrated in FIG. 9 fit different Internet-side and cellular-side network conditions, based on which (and other factors) edge node 160 will dynamically and adaptively adjust the content processing/delivery strategy. In one such example approach, 5G performance prediction and smart multipath schemes are used. For instance, 5G performance prediction service is used to provide early hints on, for example, switching from direct point cloud streaming to transcoding. Also, volumetric video content has a unique property: a point cloud stream can be flexibly split into multiple substreams; each substream containing unstructured points can be delivered and even upsampled separately. This provides tremendous flexibility for its multipath delivery over 5G and 4G.

FIG. 7 illustrates one example of the computing system of FIG. 1, in accordance with one or more techniques of the disclosure. Other examples of computing system 104 may be used in other instances and these examples may include a subset of the components included in example computing system 104 or may include additional components not shown in example computing system 104 of FIG. 7.

As shown in the example of FIG. 7, computing system 104 includes processing circuitry 205, one or more input components 213, one or more communication units 211, one or more output components 201, and one or more storage components 207. In one example approach, storage components 207 of computing system 104 include CNN 212. Communication channels 215 may interconnect each of the components 201, 203, 205, 207, 211, and 213 for inter-component communications (physically, communicatively, and/or operatively). In some examples, communication channels 215 may include a system bus, a network connection, an inter-process communication data structure, or any other method for communicating data.

One or more communication units 211 of computing system 104 may communicate with external devices, such another of computing devices 102 of FIG. 1, via one or more wired and/or wireless networks by transmitting and/or receiving network signals on the one or more networks. Examples of communication units 211 include a network interface card (e.g., such as an Ethernet card), an optical transceiver, a radio frequency transceiver, a GPS receiver, or any other type of device that can send and/or receive information. Other examples of communication units 211 may include short wave radios, cellular data radios, wireless network radios, as well as universal serial bus (USB) controllers.

One or more input components 213 of computing system 104 may receive input. Examples of input are tactile, audio, and video input. Input components 213 of computing system 104, in one example, includes a presence-sensitive input device (e.g., a touch sensitive screen), mouse, keyboard, voice responsive system, video camera, microphone or any other type of device for detecting input from a human or machine. In sonic examples, input components 213 may include one or more sensor components one or more location sensors (GPS components, Wi-Fi components, cellular components), one or more temperature sensors, one or more movement sensors (e.g., accelerometers, gyroscopes), one or more pressure sensors (e.g., barometer), one or more ambient light sensors, and one or more other sensors (e.g., microphone, camera, infrared proximity sensor, hygrometer, and the like).

One or more output components 201 of computing system 104 may generate output. Examples of output are tactile, audio, and video output. Output components 201 of computing system 104, in one example, includes a sound card, video graphics adapter card, speaker, liquid crystal display (LCD), or any other type of device for generating output to a human or machine.

Processing circuitry 205 may implement functionality and/or execute instructions associated with computing system 104. Examples of processing circuitry 205 include application processors, display controllers, auxiliary processors, one or more sensor hubs, and any other hardware configure to function as a processor, a processing unit, or a processing device. Processing circuitry 205 of computing system 104 may retrieve and execute instructions stored by storage components 207 that cause processing circuitry 205 to perform operations for processing holograms of particle fields. The instructions, when executed by processing circuitry 205, may cause computing system 104 to store information within storage components 207.

One or more storage components 207 within computing system 104 may store information for processing during operation of computing system 104. In some examples, storage component 207 includes a temporary memory, meaning that a primary purpose of one example storage component 207 is not long-term storage. Storage components 207 on computing system 104 may be configured for short-term storage of information as volatile memory and therefore not retain stored contents if powered off. Examples of volatile memories include random-access memories (RAM), dynamic random-access memories (DRAM), static random-access memories (SRAM), and other forms of volatile memories known in the art.

Storage components 207, in some examples, also include one or more computer-readable storage media. Storage components 207 in some examples include one or more non-transitory computer-readable storage mediums. Storage components 207 may be configured to store larger amounts of information than typically stored by volatile memory. Storage components 207 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 207 may store program instructions and/or information (e.g., data) associated with CNN 212. Storage components 207 may include a memory configured to store data or other information associated with assisted learning protocol 209.

Clock 203 is a device that allows computing system 104 to measure the passage of time (e.g., track system time). Clock 203 typically operates at a set frequency and measures a number of ticks that have transpired since some arbitrary starting date. Clock 203 may be implemented in hardware or software.

The techniques discussed above may be applied in predicting throughput through a network of 5G panels 106A. The techniques may also be used, for instance, to determine how to allocate channel bandwidth within 5G or within 4G and 5G. In some example approaches, the techniques are used to supplement information transferred in 4G, in low hand 5G or in combinations thereof.

In one example approach, a method is described for predicting fifth generation (5G) cellular throughput for user equipment (UE) within a three-dimensional (3D) space having a plurality of cellular nodes, the cellular nodes including two or more 5G panels, the method comprising determining, for each of a plurality of pieces of UE within the 3D space, values associated with one or more UE-side features of each piece of UE; and estimating cellular data throughput for each UE as a function of the values. On one such example approach, estimating cellular data throughput includes applying the values to a machine learning module trained using truth data associated with the one or more UE-side features. In one such example approach, the UE-side features include location within the 3D space and mobility features.

In one example approach, mobility features include direction and speed of movement relative to the 3D space for each piece of UE.

In one example approach, the UE-side features include connection-based features, the connection-based features including past values of cellular data throughput associated with the UE.

In one such example approach, the UE-side features further include tower-based features, wherein the tower-based features are selected from features including distance between panel and UE, UE-panel positional angle and UE-panel mobility angle.

In one example approach, the UE-side features include connection-based features, the connection-based features including past values of cellular data throughput associated with the UE.

In one example approach, the UE-side features include factors, associated with each respective piece of UE, that attenuate 5G signals. For example, cellular data capacity may be negatively reduced by a car when a user is driving through an area. Similarly, cellular data capacity may be negatively reduced if a user places his or her body between the closest 5G panel and a piece of UE.

In one example approach, the pieces of UE include one or more of cellular telephones, computer tablets and computers.

In one example approach, a system includes a plurality of cellular nodes, including two or more 5G panels and a computing system connected to the plurality of cellular nodes, the computing system including a machine learning module. The computer is configured to determine, for each of a plurality of pieces of UE within a 3D space surrounding the plurality of cellular nodes, values associated with one or more UE-side features of each piece of UE. The machine learning module is trained to estimate cellular data throughput for each piece of UE as a function of the values, wherein estimating cellular data throughput includes applying the values to the machine learning module after the machine learning module has been trained using truth data associated with the one or more UE-side features.

In one example approach the computing system includes one or more of a laptop, a server, or a cloud-computing platform.

In one example approach, a method is described for determining fifth generation (5G) channel selection for user equipment (UE) within a three-dimensional (3D) space having a plurality of cellular nodes, the cellular nodes including two or more 5G panels. The method includes determining, for each of a plurality of pieces of UE within the 3D space, values associated with one or more UE-side features of each piece of UE; estimating cellular data performance for each UE as a function of the values; and selecting channels to optimize cellular data performance across the plurality of pieces of UE. In one such example, estimating cellular data performance includes applying the values to a machine learning module trained using truth data associated with the one or more UE-side features; and

In one example approach, cellular data performance includes one or more of cellular data throughput, quality of service, handoff, and data prefetch.

In one example approach, a method is described for predicting fifth generation (5G) cellular data performance for user equipment (UE) deployed within a three-dimensional (3D) space having a plurality of cellular nodes, the cellular nodes including two or more 5G panels. The method includes determining, for each of a plurality of pieces of UE within the 3D space, values associated with one or more UE-side features of each piece of UE; and estimating cellular data performance for each UE as a function of the values. Estimating cellular data performance includes applying the values to a machine learning module trained using truth data associated with the one or more UE-side features.

In one example approach, claim 21, wherein estimating cellular data performance includes optimizing one or more of channel selection, cellular data throughput, quality of service, handoff, and data prefetch.

In one such example approach, the UE-side features include location within the 3D space.

In one such example approach, the UE-side features include mobility features, the mobility features including direction and speed of movement relative to the 3D space for each piece of UE.

In one such example approach, the UE-side features include connection-based features, the connection-based features including past values of cellular data throughput associated with the UE.

In one such example approach, the UE-side features include tower-based features, wherein the tower-based features are selected from features including distance between panel and UE, UE-panel positional angle and UE-panel mobility angle.

In one such example approach, the UE-side features include tower-based features selected from features including distance between panel and UE, UE-panel positional angle and UE-panel mobility angle.

Various ML-based or analytical models have been proposed for 3G/4G cellular networks. In the case of mmWave 5G throughput prediction, however, there are far more complex factors at play, and 5G throughput prediction is far more difficult than 3G/4G prediction. For example, due to various obstructions in an environment, there are far less spatial correlations. Geospatial interpolation alone is not adequate to build 5G throughput maps.

As shown earlier, the existing ML models proposed in the literature do not perform as well as the methods described above. The ML framework discussed above differs from existing 3G/4G ML models in several other aspects. All existing models use a fixed set of features for prediction (some of which may be missing or inaccessible by UE). Instead, by introducing primary and composed feature groups, our ML framework enables to select and compose feature groups that can be readily collected and relevant to the current use case and context. Furthermore, two classes of ML models were considered in conjunction with feature grouping. This takes advantage of the more powerful Seq2Seq for higher prediction accuracy, while employing lightweight, interpretable GDBT to investigate the feature importance and build best “explainable” ML models for 5G throughput prediction. In addition, the use of location agnostic tower-based features shows that there is potential in developing transferable ML models that are location-independent.

In one example approach, a method is described for predicting cellular data performance for user equipment (LE) within a three-dimensional (3D) space having a plurality of cellular nodes, the cellular nodes including two or more 5G panels and at least one 4G tower. The method includes estimating 4G cellular data performance for each UE; determining, for each of a plurality of pieces of UE within the 3D space, values associated with one or more UE-side features of each piece of UE; estimating 5G cellular data. performance for each UE as a function of the values, wherein estimating cellular data performance includes applying the values to a machine learning module trained using truth data associated with the one or more UE-side features; and determining, for each piece of UE and based on the estimated 4G cellular data performance and the estimated 5G cellular data performance, a combination of 4G data traffic and 5G data traffic needed to optimize cellular data performance across the plurality of pieces of UE. In one example method, cellular data performance includes optimizing one or more of channel selection, cellular data throughput, quality of service, handoff, and data prefetch. In another example method, the UE-side features include one or more of location within the 3D space, mobility features, connection-based features, and tower-based features.

In 3G/4G, location alone is known to be useful for predicting cellular performance. To further investigate, a dataset was constructed by holding two 5G smartphones side-by-side, one connected to a 4G network and the other to 5G and walked the 1300 m loop mentioned earlier for over 30 times spanning across multiple days, logging the perceived throughput traces. Existing approaches such as KNN classifier, OK, and RF were then applied, which are known to work well for 4G throughput estimation, to 5G traces.

Results show that the mean absolute error (MAE) on 4G traces is about [29.01, 69,13, 25.94] Mbps for KNN, OK and RF, respectively, while the same approaches on 5G traces show the MAE to be 10× higher—[325.95, 625.83, 339.57] Mbps, respectively. These results underscore that while existing models work well for predicting 4G throughput, they are unable to predict 5G throughput at mmWave 5G. This is because such methods are unable to account for the sensitivity of mmWave-based 5G to the environment a small perturbation (e.g., device orientation, moving direction, moving speed) affects 5G performance as discussed earlier. Once again, geolocation alone is not feasible to estimate mmWave based 5G performance. An ML framework has been proposed for throughput prediction that generalizes the classical location-based cellular performance prediction into context-aware prediction problem. The framework shows that in future, a data driven model may potentially use a wide range of contextual and environmental data such as location, time, mobility level, moving orientation, traffic information, etc. to model and predict 5G (all bands) LTE other lower band performance to account for the several challenges faced by mmWave.

This study points out both the opportunities and challenges in building 5G-aware apps. In particular, to tackle high bandwidth variability, new mechanisms are called for. Our preliminary study shows that existing adaptive bitrate adaption (ABR) algorithms based on throughput measurement alone do not work well to support, for example, ultra-HD (e.g., 8K) video streaming over 5G. Instead, new rate adaptation algorithms based on our ML framework for throughput prediction have been developed, with layered video coding, “content bursting” and multi-radio switching mechanisms, as discussed above.

In conclusion, despite mmWave 5G's fast attenuation and its sensitivity to environment/mobility, it is indeed feasible to predict its throughput, both qualitatively and quantitatively, via a carefully designed ML framework as described above. Composable 5G-specific features discovered from our extensive measurements may be employed, as well as expressive deep learning architectures that can mine the complex interplay between the features, to further tune the predictions. There is the potential of developing a city-level or even country-level fine-grained “performance map” of 5G services, which may benefit numerous applications over 5G.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in a computer-readable medium, such as a computer-readable storage medium, containing instructions. Instructions embedded or encoded in a computer-readable storage medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a cassette, magnetic media, optical media, or other computer readable media.

What is claimed is:

1. A method for predicting one or more cellular performance parameters associated with user equipment (UE) within a three-dimensional (3D) space having one or more cellular nodes, the cellular nodes including one or more cellular nodes, including a 5G cellular node, the method comprising:
determining, for each of one or more of pieces of UE within the 3D space, values associated with one or more UE-side features of each piece of UE; and
predicting values of the one or more cellular performance parameters for each UE as a function of the values associated with the one or more UE-side features of each respective piece of UE,
wherein predicting values of the one or more cellular performance parameters includes applying the values determined for each respective piece of UE to a machine learning module trained using truth data associated with the one or more UE-side features.

2. The method of claim 1, wherein the cellular performance parameters include one or more of cellular data throughput, signal strength and level of carrier aggregation.

3. The method of claim 2, wherein cellular data throughput is one or more of downlink throughput and uplink throughput.

4. The method of claim 1, wherein the method further comprises:
selecting network channels based on the predicted values of the one or more cellular performance parameters to optimize one or more of cellular data throughput, quality of service, handoff, and data prefetch across the one or more pieces of UE.

5. The method of claim 1, wherein the method further comprises:
predicting cellular data performance across the one or more pieces of UE based on the predicted values of the one or more cellular performance parameters.

6. The method of claim 1, wherein the UE-side features include mobility features, the mobility features including direction and speed of movement relative to the 3D space for each piece of UE.

7. The method of claim 6, wherein at least one of the pieces of user equipment is not moving within the 3D space.

8. The method of claim 1, wherein the UE-side features include connection-based features.

9. The method of claim 8, wherein the UE-side features further include tower-based features, wherein the tower-based features are selected from features including distance between panel and UE, UE-panel positional angle and UE-panel mobility angle.

10. The method of claim 1, wherein the UE-side features include tower-based features.

11. The method of claim 10, wherein the tower-based features are selected from features including distance between panel and UE, UE-panel positional angle and UE-panel mobility angle.

12. The method of claim 11, wherein the UE-side features further include mobility features.

13. The method of claim 12, wherein the UE-side features further include connection-based features, the connection-based features including past values of cellular data throughput associated with the UE.

14. The method of claim 1, wherein the UE-side features include factors, associated with each respective piece of UE, that attenuate 5G signals.

15. The method of claim 1, wherein the UE-side features include mobility features, the mobility features including direction and speed of movement relative to the 3D space for each piece of UE.

16. The method of claim 1, wherein the pieces of UE include one or more of cellular telephones, computer tablets and computers.

17. A system comprising:
one or more cellular nodes, including one or more 5G panels; and
a computing system connected to the cellular nodes, the computing system including a machine learning module,
wherein the computing system is configured to determine, for each of one or more pieces of user equipment (UE) within a 3D space surrounding the plurality of cellular nodes, values associated with one or more UE-side features of each piece of UE, and
wherein the machine learning module is trained to predict values of one or more cellular performance parameters for each piece of UE as a function of the values associated with the one or more UE-side features of each respective piece of UE, wherein predicting values of the one or more cellular performance parameters includes applying the values determined for each respective piece of UE to the machine learning module after the machine learning module has been trained using truth data associated with the one or more UE-side features.

18. The system of claim 17, wherein the cellular performance parameters include one or more of cellular data throughput, signal strength and level of carrier aggregation.

19. The system of claim 18, wherein the computing system comprises a laptop, a server, or a cloud-computing platform.

20. A non-transitory, computer-readable medium comprising executable instructions; which when executed by processing circuitry, cause a computing device to:
determine, for each of one or more of pieces of UE within a 3D space, values associated with one or more UE-side features of each piece of UE; and
predict values of the one or more cellular performance parameters for each UE as a function of the values associated with the one or more UE-side features of each respective piece of UE, wherein predicting values of the one or more cellular performance parameters includes applying the values determined for each respective piece of UE to a machine learning module trained using truth data associated with the one or more UE-side features.

21. A method for predicting cellular performance for user equipment (UE) within a three-dimensional (3D) space having a plurality of cellular nodes, the cellular nodes including two or more 5G panels and at least one 4G tower, the method comprising:
estimating 4G cellular performance for each UE;
determining, for each of a plurality of pieces of UE within the 3D space, values associated with one or more UE-side features of each piece of UE;
estimating 5G cellular performance for each UE as a function of the values, wherein estimating cellular performance includes applying the values to a machine learning module trained using truth data associated with the one or more UE-side features; and
determining, for each piece of UE and based on the estimated 4G cellular data performance and the estimated 5G cellular data performance, a combination of 4G data traffic and 5G data traffic needed to optimize cellular performance across the plurality of pieces of UE.

22. The method of claim 21, wherein cellular performance includes optimizing one or more of channel selection, cellular data throughput, quality of service, handoff, and data prefetch.
